(19) United States
(12) Patent Application Publication
(10) Pub. No.: US 2015/0112593 A1
(43) Pub. Date: Apr. 23, 2015

(54) Humanized Navigation Instructions for Mapping Applications

(71) Applicant: Apple Inc., Cupertino, CA (US)

(72) Inventors: Anil K. Kandangath, Santa Clara, CA (US); Xiaoyuan Tu, Sunnyvale, CA (US)

(73) Assignee: Apple Inc., Cupertino, CA (US)

(21) Appl. No.: 14/061,208

(22) Filed: Oct. 23, 2013

(51) Int. Cl. G01C 21/36

(52) U.S. Cl. CPC G01C 21/3644; G01C 21/3629
USPC 701/541; 701/400

(57) ABSTRACT

A humanized navigation system provides humanized instructions that mimic a real human navigator, focuses on comprehension rather than precision, and attempts to make the navigation session less stressful for the user. In some implementations, complex navigation situations are classified according to shared common navigation problems. Once a class is determined, humanized navigation instructions are generated and/or selected based on the class and the current location of the user. The humanized navigation instructions include information to aid the user in navigating a route.

### TECHNICAL FIELD

This disclosure relates generally to mapping applications for navigation devices.

### BACKGROUND

Many modern mobile devices (e.g., a smart phone, e-tablet, wearable devices) include a navigation system. The navigation system can include a microprocessor that executes a software navigation application that uses data from one or more inertial sensors (e.g., accelerometer, gyro, magnetometer) and one or more positioning systems (e.g., GPS, Wi-Fi, cell tower) to determine the current location and direction of travel of the mobile device. The navigation application allows a user to input a desired destination and calculates a route from the current location to the destination according to the user's preferences. A map display includes markers to show the current location of the mobile device, the desired destination and points of interest (POI) along the route. Some navigation applications can provide a user with turn-by-turn directions. The directions can be presented to the user on the map display and/or by audio output.

Conventional navigation instructions are mechanical and not easily understood by many users. For example, a conventional navigation instruction may be “turn right in 0.3 miles to street x.” Many users cannot estimate 0.3 miles, and if the street sign for “street x” is not visible the turn can be missed. Another example instruction may be “head north.” Heading north is not easy if the user does not know the direction of north. Another instruction may be “in 600 feet, arrive at your destination on the right.” In cities with densely packed POIs, it may not be obvious where the destination is located, especially since the location accuracy may not be good enough for the ‘600 feet’ number to be trusted.

In addition to being overly mechanical, conventional navigation instructions do not account for the mental state of a user and can often confuse and frustrate the user who may be lost in an unfamiliar location.

### SUMMARY

A humanized navigation system provides humanized instructions that mimic a real human navigator, focuses on comprehension rather than precision, and attempts to make the navigation session less stressful for the user. In some implementations, complex navigation situations are classified according to shared common navigation problems. Once a class is determined, humanized navigation instructions are generated and/or selected based on the class and the current location of the user. The humanized navigation instructions include information to aid the user in navigating a route.

For navigation session starts, the user can be instructed to move relative to a landmark. When arriving at a destination, information can be included in a humanized navigation instruction that describes visible attributes of the destination, nearby landmarks, destination surroundings and the relative location of the destination with respect to landmarks, an intersection or traffic. For freeway entry, exit and changes, humanized navigation instructions can include advance warnings to help the user select the correct entry or exit ramp for a freeway or provide lane information to assist the user during freeway changes. For turns, information can be included in the humanized navigation instruction that describes the number of turns coming up and/or using landmarks and/or street signs. For re-routing, information can be included in a humanized navigation instruction that describes cost estimates for taking an alternative route or that reassure the user that new instructions are forthcoming.

In some implementations, a method comprises: determining a complex navigation situation has been encountered by a navigation device; determining one or more landmarks or attributes associated with a current location of the navigation device; and generating a humanized navigation instruction using the one or more landmarks or attributes.

In some implementations, a method comprises: determining that a navigation device has deviated from a route to a destination; calculating an alternative route to the destination; calculating a cost associated with the alternative route; generating a humanized navigation instruction including the calculated cost; and providing the humanized navigation instruction to a user of the navigation device.

Other implementations are directed to devices and computer-readable mediums.

Particular implementations disclosed herein provide one or more of the following advantages. Humanized navigation instructions reduce the stress that users experience in difficult navigation scenarios.

The details of the disclosed implementations are set forth in the accompanying drawings and the description below. Other features, objects, and advantages will be apparent from the description and drawings and from the claims.

### DESCRIPTION OF DRAWINGS

FIG. 1 is a block diagram of an example operating environment for a humanized navigation system (HNS).

FIG. 2 is a block diagram of an example operating environment for a navigation service that assists the HNS.

FIG. 3 illustrates an example route traveled by a user using humanized navigation instructions.

FIG. 4 is a flow diagram of an example process for providing humanized navigation instructions.

FIG. 5 is a flow diagram of an example process for providing humanized navigation instructions for a re-routing situation.

FIG. 6 is a block diagram of exemplary device architecture for implementing the features and processes described in reference to FIGS. 1-5.

The same reference symbol used in various drawings indicates like elements.

### DETAILED DESCRIPTION

Example Human Navigation Operating Environments

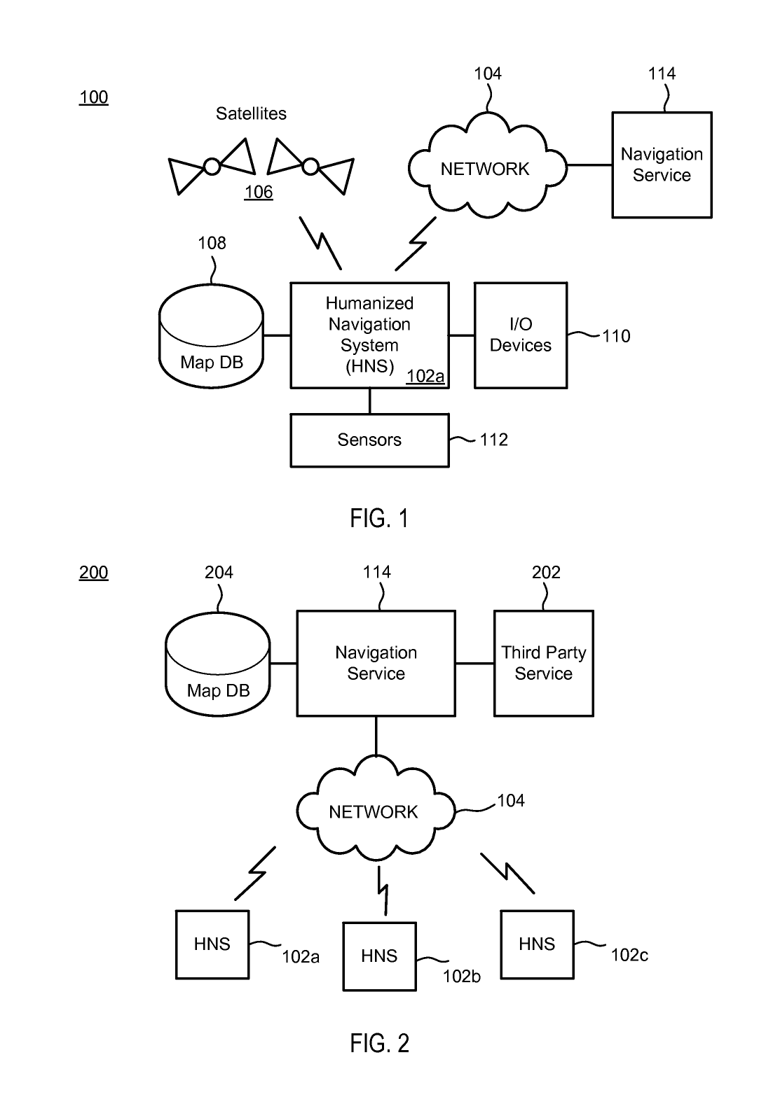

FIG. 1 is a block diagram of an example operating environment for a humanized navigation system (HNS). In some implementations, operating environment 100 can include HNS 102a, network 104, navigation satellites 106, map database 108, input/output (I/O) devices 110, sensors 112 and navigation service 114.

HNS 102a can be implemented in a mobile device, such as a smartphone, e-tablet, wearable device (e.g., wristwatch) or embedded in another system, such as a car or vessel navigation system. HNS 102a can include a global navigation satellite system (GNSS) receiver, such as a Global Positioning System (GPS) receiver chip or chip set that calculates position and velocity using satellites 106.

Sensors 112 can include one or more inertial navigation sensors (INS) including but not limited to accelerometers, gyro sensors and a magnetometer. HNS 102a can include one or more microprocessors for communicating with network 104 (e.g., Wi-Fi network or cellular network) using known communication protocols. Network 104 can be coupled to navigation service 114 that can send navigation information to HNS 102a through network 104, such as map information, POI metadata and traffic information. HNS 102a can have one or more I/O devices 110, such as a keyboard or other input mechanism, a display (e.g., an LCD display) for presenting maps and route information, and audio output (e.g., loudspeaker) for providing voiced navigation instructions. HNS 102a can receive map information locally from map database 108 stored on a disk (e.g., a CD ROM, DVD) or in memory and/or receive map information from navigation service 114 through network 104. In some implementations, HNS 102a can include or be coupled with a voice recognition subsystem for receiving navigation commands from a user.

FIG. 2 is a block diagram of an example operating environment 200 for navigation service 114. In some implementations, operating environment 200 can include navigation service 114, third party service 202, map database 204, network 104 and HNS 102a, 102b, 102c. Although three HNS are shown, in practice there can be any number of HNS communicating with navigation service 114 through network 104.

Navigation service 114 can include one or more server computers and communication interfaces for bi-directional wireless communications with HNS 102a, 102b, 102c through network 104. Navigation service 114 can send navigation information to HNS 102a, 102b, 102c, such as map information, POI data and traffic information, which, in some implementations, can be received from third party service 202.

Compared to conventional navigation instructions that primarily provide instructions based on distance to the next action point (e.g., turns), a humanized navigation system utilizes a rich variety of data sources such as POIs, traffic conditions, landmarks, etc. to provide humanized navigation instructions for complex navigation situations. Humanized navigation instructions mimic the instructions that would likely be provided by a human navigator. Humanized navigation instructions can provide “eyes-free” audio navigation where it is important to provide instructions that are comprehensible to a driver who cannot see a map. For navigation scenarios where the driver can see the map, providing humanized navigation instructions can make the user's navigation experience less stressful.

For simple navigation situations it may be unnecessary to provide humanized navigation instructions. In simple navigation situations, providing humanized navigation instructions may be annoying to the user who would prefer shorter and/or less detailed instructions for simple navigation situations. Accordingly, in some implementations humanized navigation instructions are provided only when a complex (potentially confusing) navigation situation arises for a user. HNS 102a can automatically determine that a complex navigation situation has been encountered and replace or augment a mechanical navigation instruction with a humanized navigation instruction. In some implementations, complex navigation situations can be classified. Some example classes include but are not limited to: Navigation Session Start, Arrival at Destination, Freeway Entry/Exit/Change, Turns and Re-routing. Each example class will now be described in turn. Other classes are also possible.

### Navigation Session Start

When a user starts a new navigation session, the Navigation Session Start class will be used to determine if the session start is potentially confusing to the user. After the Navigation Session Start class is identified, the HNS can reverse geocode the current location of the user to see if the user is in a parking lot or other structure and generate a list of landmarks proximate to the user's current location. If, for example, the user is in a parking lot, then data for the parking lot can identify exit locations in geographic coordinates (e.g., latitude, longitude, altitude), which can be obtained from local database 108 or navigation service 114. Using the user's current location, locations of the exits and the list of landmarks, the best exit for the user can be identified (e.g., the closest exit or the best exit to place the user on a calculated route) and a humanized instruction can be generated that can direct the user to the exit. For example, if the user is currently in a mall parking lot, the user can be instructed to find an exit relative to a landmark and then be provided with turn-by-turn guidance. For example, “exit the parking lot near AppleBees® restaurant and then turn right towards Golden Ave.” Another example instruction could be “head north towards the AMC® cinema.”

### Arrival at Destination

When a user approaches a destination within a threshold distance (e.g., 0.5 miles), the Arrival at Destination class will be used to determine if the destination is potentially confusing to the user. Based on the user's current location and the location of the destination, data for the destination can be obtained and included in the humanized navigation instruction. The data can be obtained from public or private data sources (e.g., map database, floor plans for a building), crowd-sourced information and/or traditional map surveying methods. For example, an existing map database can be extended to include additional data for a geographic location (e.g., landmarks) to be used to generate humanized navigation instructions.

In some cases, a noticeable attribute of the destination can be included in the humanized navigation instruction. For example, an instruction might include a visual attribute: “your destination is on the right in the red building.” In this example, data for the destination included a color attribute that was described in the humanized navigation instruction to assist the user in visually identifying their destination.

In some cases, a nearby landmark can be described in the humanized navigation instruction. For example, “your destination is the apartment complex with the water fountain in the front.”

In some cases, the destination surroundings can be described in the humanized navigation instruction. For example, “your destination is in the strip mall to your right.”

In some cases, the location of the destination can be described relative to a landmark. For example, “your destination is behind OfficeMax,” or “your destination is inside Westfield Mall to your right.”

In some cases, the location of the destination can be described relative to an intersection or traffic. For example, “take the first right after the light,” or “take the second entry into the mall.”

### Freeway Entry/Exit/Change

When a user approaches a freeway entrance, exit or interchange within a threshold distance, the Freeway Entry/Exit/Change class will be used to generate humanized navigation instructions. For example, both the entry ramps for a freeway (e.g., south and north) may be on the same side of the road, and a user may take the wrong onramp. Under such conditions, humanized navigation instructions can be generated to warn the user of this potentially confusing situation. For example, “enter 280S to your right. The entry ramp will be the second freeway entry on your right.”

Freeway exits may require advance warning so that the user can merge to the correct lane in time. Various conditions may be used to determine that a humanized navigation instruction is necessary. Some example conditions include but are not limited to traffic conditions, historic data and manual mark. For example, if traffic is heavy merging to the correct lane to make an exit may be difficult. In this case, a humanized navigation instruction can be provided to the user to guide the user to the correct lane. If it is known from historic data that users frequently miss navigation instructions at this exit, a humanized instruction can be provided to clarify the correct lane to exit. A tough exit may also be marked manually in a map by the user. When the marked exit is encountered by the user, a humanized navigation instruction can be provided to clarify the correct lane to exit. For example, “start merging to the right-most lane to take the exit in 1 mile.”

Historic data and manual marks can be based on crowd-sourced data provided by users that have encountered the exit in the past. For example, if the user selected an option to share their location, the HNS can send data to navigation service 114 identifying the exit as being missed. The data can be sent anonymously without any user-identifying information. Navigation service 114 can process the data from a large number of user devices, and when a sufficient number of users miss the exit, navigation service 114 can mark the exit location in a map database to indicate that the exit requires humanized navigation instructions.

Freeway interchanges (e.g., where freeways split into multiple freeways) can be potentially confusing to a user. When the user is within a threshold distance of a freeway interchange, a humanized navigation instruction can be given that guides the user to the correct lane for changing freeways. For example, “stay on one of the two left-most lanes to continue on 280N,” or “stay in the middle lane to continue on to the Bay Bridge,” or “stay on the right-most lane and exit on to 85N.”

### Turns

When a user approaches a turn within a threshold distance, the Turns class will be used to generate humanized navigation instructions. In residential neighborhoods, multiple lanes are often close to each other. In such situations, mechanical instructions such as “turn right in 600 ft” can often be confusing to a user. If the lanes are known to be close to each other (e.g., from map data), humanized navigation instructions can be provided that account for the number of turns coming up. For example, “take the turn after the next one.”

Additionally, landmarks and street signs can be included in humanized navigation institutions. For example, “turn right after the school building” or turn right at the next stop sign.”

### Re-Routing

Re-routing can often be stressful to users, especially if they are lost. If the re-routing is determined to be significant, HNS 102a can inform the user that they missed a turn and provide an estimate of what the re-routing will cost them in turns of time and/or fuel. The time cost of missing a turn can be calculated as the difference it makes to the arrival time. If the difference is determined to be above a certain threshold, HNS 102a can inform the user of the time cost. If fuel information is known, then a fuel cost may also be provided to the user. For example, “you missed a turn and will have to be re-routed. You will now arrive at your destination in 16 minutes.” If a user misses a turn and re-routing information is not available immediately, the user can be re-assured while the new instructions are being fetched. For example, “stay on this road while a new route is being prepared.”

In some implementations, if the cost is above a threshold, HNS 102a can take some action. Example actions can include but are not limited to sending (or having sent by another device) a text message, e-mail, telephone call, tweet to another individual or entity. Such communications can include a warning that the user will be late and the estimated time of arrival. Contact information for individuals or entities can be obtained from an address book, calendar or other data structure stored locally or on a network.

### Example Route Using Humanized Instructions

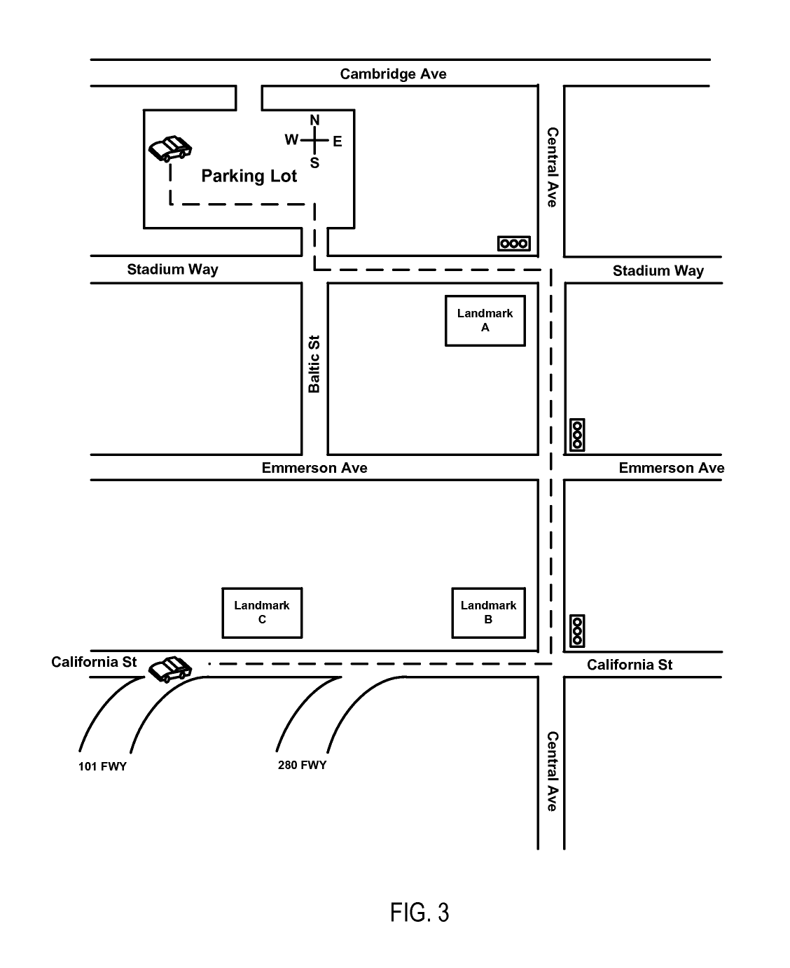

FIG. 3 illustrates an example route traveled by a user using humanized instructions. In this example, a user has parked their car in a parking lot and would like to go home via the 101 freeway. The user inputs his home address into FINS 102a (e.g., a car navigation system or a mounted mobile device with a navigation application) and any other preferences such the shortest route, avoid toll roads, etc. HNS 102a calculates a route to the destination and displays it on a map display. FIG. 3 depicts a portion of the map display showing a route from the parking lot to the 101 freeway (indicated by a dashed line).

After calculating the route, HNS 102a determines the navigation situation. The current location of the car can determined by reverse geocoding the latitude and longitude coordinates computed by a GNSS receiver to determine that the user is in a parking lot and the locations of all exits in the parking lot. An accelerometer embedded in or coupled to HNS 102a data can indicate that the user is stationary. From this data, HNS 102a can determine the navigation situation of the user and select the appropriate navigation situation class. In this example, HNS 102a determined that the south parking lot exit was the most appropriate exit for the user according to the route. HNS 102a generates the humanized instruction “take the south exit of the parking lot and head east on Stadium Way.”

The user exits from the south exit of the parking lot and heads east on Stadium Way. The user eventually approaches Central Ave. HNS 102a determines that the user is within a threshold distance (e.g., 0.5 miles) of Central Ave and will need to make a right turn to continue on the route. HNS 102a recognizes the current navigation situation as turning. HNS 102a determines that Landmark A is on the corner of Stadium Way and Central Ave. HNS 102 generates the navigation instruction: “In 0.5 miles make a right turn at the first traffic light onto Central Ave and head south. Landmark A (e.g., a library) will be on your right side.”

The user continues driving south on Central Ave. HNS 102a detects that the user is approaching two cross streets in a row with traffic lights and the second cross street is California Street. HNS 102 recognizes the current navigation situation as Turn class. HNS 102a knows from the route information that the user needs to make a right turn at the second street light and head west on California Street. HNS 102a determines that Landmark B (e.g., an elementary school) is located at the intersection of Central Ave and California Street. HNS 102a generates the navigation instruction: “In 0.5 miles, make a right turn at the second traffic light. Landmark B will be on your right side.”

The user continues driving west on California Street. HNS 102a determines that the user is approaching two freeway onramps in a row and that the second onramp is for the 101 freeway. HNS 102a recognizes the navigation situation to be freeway entrance. HNS 102a determines that Landmark C (e.g., a gas station) is located on the right side of California Street just before the second onramp. HNS 102a generates the navigation instruction: “In 0.5 miles, take the second freeway onramp just past Landmark C, which will be on your right side.”

The example route navigation described above illustrates how navigation instructions can be humanized by determining the navigation situation of the user then identifying landmarks, attributes, streetlights and freeway on-ramps/off-ramps along the route. When HNS 102a determines that the user is within a threshold distance of a complex navigation situation (e.g., a freeway entrance), HNS 102a generates a humanized navigation instruction. The humanized navigation instruction can be presented on a map display and/or voiced through an audio system of the car or other navigation device. The humanized navigation instructions mimic a human navigator. For example, a human passenger acting as a navigator would provide instructions similar to those in the above example to ensure the driver understands the instructions rather than being technically precise. These enriched instructions can be compared with conventional navigation instructions, which are mechanical and more focused on precision than in comprehension.

Although the example described above assumes that the user was in a car, the HNS can be used by a pedestrian, bicyclist, mass transit (e.g. bus, train) or with any other mode of transportation. In some implementations, in addition to providing instructions to the user, the FINS can provide a street view image to further assist the user in managing a complex navigation situation. For example, an image of a landmark can be provided to the user in addition to or in place of a text or audio description of the landmark.

### Example Processes

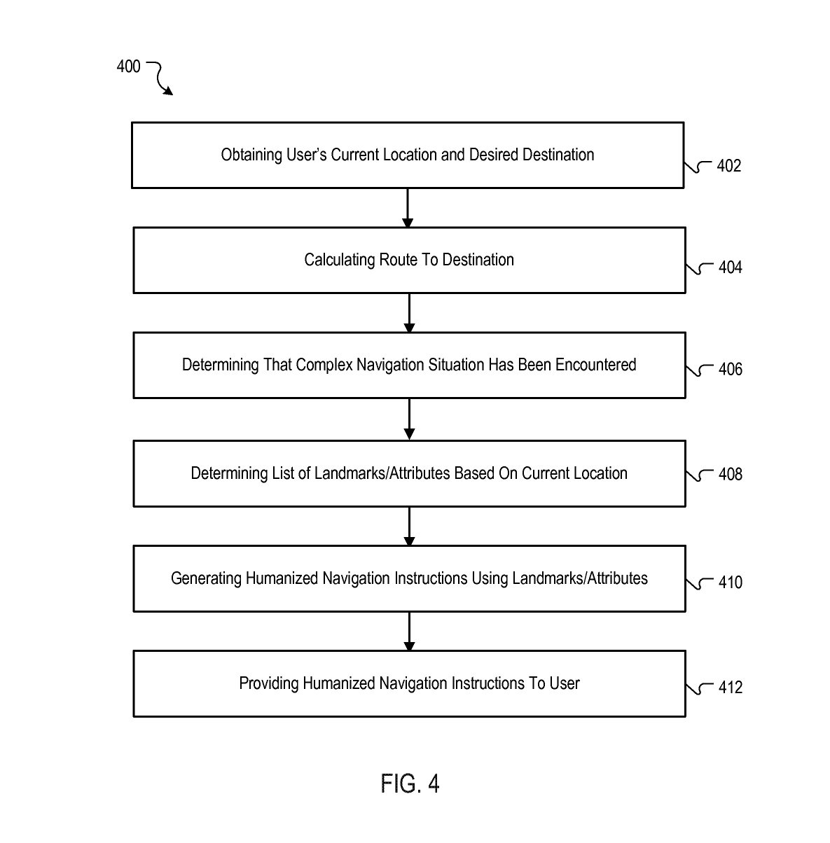

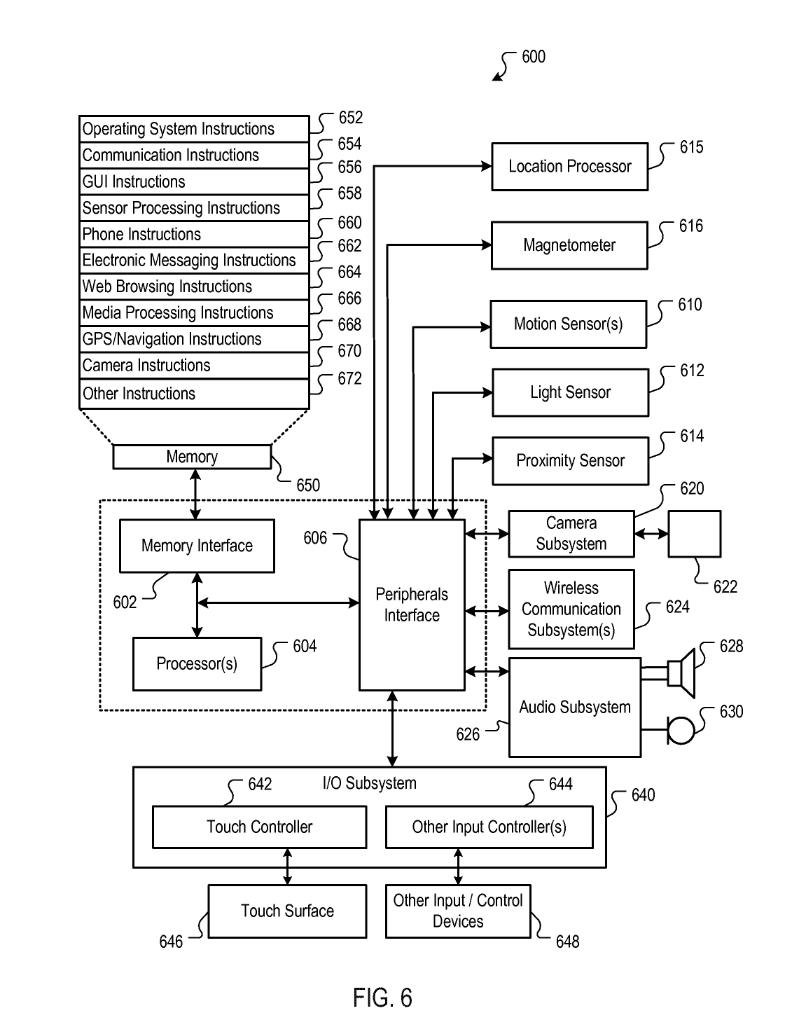

FIG. 4 is a flow diagram of an example process 400 for providing humanized navigation instructions. Process 400 can be implemented using, for example, the device architecture described in reference to FIG. 6.

In some implementations, process 400 can begin by obtaining a user's current location and desired destination (402). For example, the user can speak navigation commands like “navigate to nearest 280S freeway entrance” into a microphone of their navigation device. Alternatively, the user can type in a destination address using an input device (e.g., a keyboard, rotary dial). The user's current location can be determined by on board positioning technology (e.g., GPS, Wi-Fi, cellular).

Process 400 can continue by calculating a route to the destination (404). The route can be calculated using known route calculation algorithms (e.g., Dijkstra's shortest path, A-Star).

Process 400 can continue by determining a complex navigation situation related to navigation device (406). A complex navigation situation is a navigation situation where there is potential for a user to be confused. Process 400 monitors the current location of a user and sensor data (e.g., speed, direction or heading) and determines when the user has encountered a complex navigation situation. Complex navigation situations can be classified as previously described. For example, if HNS determines that the user is parked in a mall parking lot, the navigation situation will be classified as Navigation Session Start.

In some implementations, the map database used by the HNS can have geographic locations marked as complex based on map surveys, crowd-sourced data, traffic information or any other data source. In some implementations, a geographic location can be marked complex for only certain times of the day (e.g., at night) or weather conditions (e.g., rain, snow, fog), as such conditions can make a normally routine navigation situation complex due to decreased visibility of road signs, etc.

Process 400 can continue by determining a list of landmarks and/or attributes based on the navigation situation (408). Landmarks can include any visible POIs, buildings or structures, such as government buildings, schools, hospitals, libraries, museums, gas stations, office buildings and the like. Attributes can include visible characteristics or features of a building or structure, such as color, architecture, landscaping, size, shape, number of stories or floors, the name of the building or structure and any other characters or features that a user can easily see when the particular complex navigation situation is encountered.

Process 400 can continue by generating humanized navigation instructions using the landmarks and attributes (410). The instructions can be created a prior or on-the-fly depending on the navigation situation. For example, if the HNS determines that the user is in the middle lane of a freeway and within 0.5 miles of a freeway interchange and the route requires the user to change freeways, a Freeway Entry/Exit/Change is determined and an appropriate humanized navigation instruction is generated or obtained from a local or network database. The humanized navigation instruction can be provided to the user on a map display and/or voiced from a loudspeaker (412).

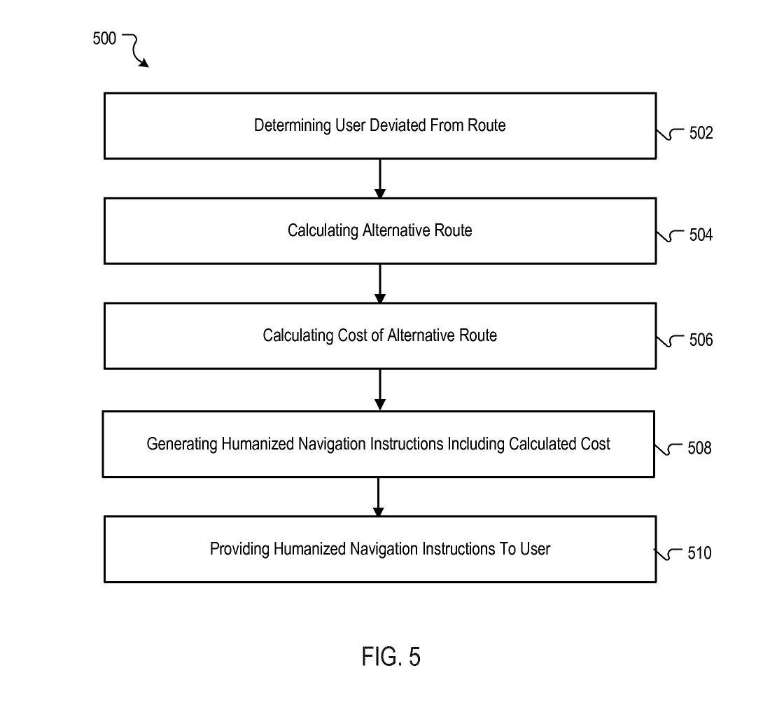

FIG. 5 is a flow diagram of an example process 500 for providing humanized navigation instructions for a re-routing situation. Process 500 can be implemented using, for example, the device architecture described in reference to FIG. 6.

In some implementations, process 500 can begin by determining that a user deviated from a route (502). Deviation can include missing a turn or exit or otherwise deviating from the calculated route. In some implementations, the user's direction and speed can be used to determine route deviation.

Process 500 can continue by calculating an alternative route (504). Alternative routes can be computed using known alternative route calculation algorithms.

Process 500 can continue by calculating a cost of the alternative route (506). Cost can be time cost, fuel cost or any other desired cost parameter. For example, time cost can be calculated based on the distance to the destination, the current speed of the user and traffic data if available. If in-vehicle navigation is being used, fuel costs can be determined based on an estimated miles per gallon (mpg) for the user's vehicle or vessel.

Process 500 can continue by generating humanized navigation instructions including the calculated cost (508). Process 500 can continue by providing the humanized navigation instructions to the user (510). The humanized navigation instructions can be provided to the user on a map display and/or voiced from a loudspeaker.

### Example Mobile Device Architecture

FIG. 6 is a block diagram of exemplary device architecture for implementing the features and processes described in reference to FIGS. 1-5.

Architecture 600 may be implemented in any device for generating the features described in reference to FIGS. 1-5, including but not limited to portable or desktop computers, smart phones and electronic tablets, television systems, game consoles, kiosks and the like. Architecture 600 may include memory interface 602, data processor(s), image processor(s) or central processing unit(s) 604, and peripherals interface 606. Memory interface 602, processor(s) 604 or peripherals interface 606 may be separate components or may be integrated in one or more integrated circuits. One or more communication buses or signal lines may couple the various components.

Sensors, devices, and subsystems may be coupled to peripherals interface 606 to facilitate multiple functionalities. For example, motion sensor 610, light sensor 612, and proximity sensor 614 may be coupled to peripherals interface 606 to facilitate orientation, lighting, and proximity functions of the device. For example, in some implementations, light sensor 612 may be utilized to facilitate adjusting the brightness of touch surface 646. In some implementations, motion sensor 610 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 606, such as a temperature sensor, a biometric sensor, or other sensing device, to facilitate related functionalities.

Location processor 615 (e.g., GPS receiver) may be connected to peripherals interface 606 to provide geo-positioning. Electronic magnetometer 616 (e.g., an integrated circuit chip) may also be connected to peripherals interface 606 to provide data that may be used to determine the direction of magnetic North. Thus, electronic magnetometer 616 may be used as an electronic compass.

Camera subsystem 620 and an optical sensor 622, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 624. Communication subsystem(s) 624 may include one or more wireless communication subsystems. Wireless communication subsystems 624 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 624 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 624 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 626 may be coupled to a speaker 628 and one or more microphones 630 to facilitate voice-enabled functions, such as voice recognition, voice replication, digital recording, and telephony functions.

I/O subsystem 640 may include touch controller 642 and/or other input controller(s) 644. Touch controller 642 may be coupled to a touch surface 646. Touch surface 646 and touch controller 642 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 646. In one implementation, touch surface 646 may display virtual or soft buttons and a virtual keyboard, which may be used as an input/output device by the user.

Other input controller(s) 644 may be coupled to other input/control devices 648, such as one or more buttons, rocker switches, thumb-wheel, infrared port, USB port, and/or a pointer device such as a stylus. The one or more buttons (not shown) may include an up/down button for volume control of speaker 628 and/or microphone 630.

In some implementations, device 600 may present recorded audio and/or video files, such as MP3, AAC, and MPEG files. In some implementations, device 600 may include the functionality of an MP3 player and may include a pin connector for tethering to other devices. Other input/output and control devices may be used.

Memory interface 602 may be coupled to memory 650. Memory 650 may include high-speed random access memory or non-volatile memory, such as one or more magnetic disk storage devices, one or more optical storage devices, or flash memory (e.g., NAND, NOR). Memory 650 may store operating system 652, such as Darwin, RTXC, LINUX, UNIX, OS X, WINDOWS, or an embedded operating system such as VxWorks. Operating system 652 may include instructions for handling basic system services and for performing hardware dependent tasks. In some implementations, operating system 652 may include a kernel (e.g., UNIX kernel).

Memory 650 may also store communication instructions 654 to facilitate communicating with one or more additional devices, one or more computers or servers. Communication instructions 654 may also be used to select an operational mode or communication medium for use by the device, based on a geographic location (obtained by the GPS/Navigation instructions 468) of the device. Memory 650 may include graphical user interface instructions 656 to facilitate graphic user interface processing, including a touch model for interpreting touch inputs and gestures; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes, such as the processes described in reference to FIGS. 4 and 5; camera instructions 670 to facilitate camera-related processes and functions; and instructions 672 for implementing some or all of the features and processes described in reference to FIGS. 1-5.

Each of the above identified instructions and applications may correspond to a set of instructions for performing one or more functions described above. These instructions need not be implemented as separate software programs, procedures, or modules. Memory 650 may include additional instructions or fewer instructions. Furthermore, various functions of the device may be implemented in hardware and/or in software, including in one or more signal processing and/or application specific integrated circuits.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining a complex navigation situation has been encountered by a navigation device;
determining one or more landmarks or attributes associated with a current location of the navigation device; and
generating a humanized navigation instruction using the one or more landmarks or attributes,
where the method is performed by one or more hardware processors.

2. The method of claim 1, further comprising:
providing the humanized navigation instructions to a display device or audio output device of the navigation device.

3. The method of claim 2, further comprising:
providing a street scene image of a landmark to the navigation device.

4. The method of claim 1, where the navigation device is a mobile device docked to a vehicle or vessel.

5. The method of claim 1, where the complex navigation situation is a navigation session start and the humanized navigation instruction instructs a user to move relative to a landmark.

6. The method of claim 1, where the complex navigation situation is arrival at a destination and the humanized navigation instruction includes a visible attribute of the destination.

7. The method of claim 1, where the complex navigation situation is arrival at a destination and the humanized navigation instruction describes nearby landmarks.

8. The method of claim 1, where the complex navigation situation is arrival at a destination and the humanized navigation instruction describes destination surroundings.

9. The method of claim 1, where the complex navigation situation is arrival at a destination and the humanized navigation instruction describes a relative location of the destination.

10. The method of claim 1, where the complex navigation situation is arrival at a destination and the humanized navigation instruction describes a relative location of the destination with respect to an intersection or traffic.

11. The method of claim 1, where the complex navigation situation is a freeway entrance and the humanized navigation instruction describes the freeway entrance relative to another freeway entrance at the current location.

12. The method of claim 1, where the complex navigation situation is a freeway exit and the humanized navigation instruction is generated in response to at least one of traffic conditions, historic data and a manual mark.

13. The method of claim 1, where the complex navigation situation is a freeway change and the humanized navigation instruction describes a lane for making the freeway change.

14. The method of claim 1, where the complex navigation situation is a turn and the humanized instruction accounts for a number of turns coming up on the route.

15. The method of claim 1, where the complex navigation situation is a turn and the humanized navigation instruction describes a landmark, street light or street sign.

16. A method comprising:
determining that a navigation device has deviated from a route to a destination;
calculating an alternative route to the destination;
calculating a cost associated with the alternative route;
generating a humanized navigation instruction including the calculated cost; and
providing the humanized navigation instruction to a user of the navigation device.

17. The method of claim 16, where the calculated cost is a time cost or a fuel cost.

18. The method of claim 16, where the humanized navigation instruction includes a confirmation that an alternative route is being calculated.

19. The method of claim 17, where if the calculated cost exceeds a threshold value, an action is initiated.

20. The method of claim 19, where the action is one or more of sending a text message, e-mail, telephone call or tweet to another device.

21. A system comprising:
one or more processors;
memory coupled to the one or more processors and configured to store instructions, which, when executed by the one or more processors, causes the one or more processors to perform operations comprising:
determining a complex navigation situation has been encountered by the system;
determining one or more landmarks or attributes associated with a current location of the system; and
generating humanized navigation instruction using the one or more landmarks or attributes.

22. The system of claim 21, the operations further comprising:
providing the humanized navigation instruction to a display device or audio output device of the system.

23. The system of claim 22, where a street scene image of the landmark is provided to the system.

24. The system of claim 21, where the system is a mobile device docked to a vehicle or vessel.

25. The system of claim 21, where the complex navigation situation is a navigation session start and the humanized navigation instruction instructs a user to move relative to a landmark.

26. The system of claim 21, where the complex navigation situation is arrival at a destination and humanized navigation instruction includes a visible attribute of the destination.

27. The system of claim 21, where the complex navigation situation is arrival at a destination and the humanized navigation instruction describes nearby landmarks.

28. The system of claim 21, where the complex navigation situation is arrival at a destination and the humanized navigation instruction describes destination surroundings.

29. The system of claim 21, where the complex navigation situation is arrival at a destination and the humanized navigation instruction describes a relative location of the destination.

30. The system of claim 21, where the complex navigation situation is arrival at a destination and the humanized navigation instruction describes a relative location of the destination with respect to an intersection or traffic.

31. The system of claim 21, where the complex navigation situation is a freeway entrance and the humanized navigation instruction describes the freeway entrance relative to another freeway entrance at the current location.

32. The system of claim 21, where the complex navigation situation is a freeway exit and the humanized navigation instruction is generated in response to at least one of traffic conditions, historic data and a manual mark.

33. The system of claim 21, where the complex navigation situation is a freeway change and the humanized navigation instruction describes a lane for making the freeway change.

34. The system of claim 21, where the complex navigation situation is a turn and the humanized instruction accounts for a number of turns coming up on the route.

35. The system of claim 21, where the complex navigation situation is a turn and the humanized navigation instruction describes a landmark, street light or street sign.

36. A system comprising:
one or more processors;
memory coupled to the one or more processors and configured to store instructions, which, when executed by the one or more processors, causes the one or more processors to perform operations comprising:
determining that the system has deviated from a route to a destination;
calculating an alternative route to the destination;
calculating a cost associated with the alternative route;
generating humanized instructions including the calculated cost; and
providing the humanized instructions to a user of the system.

37. The system of claim 36, where the calculated cost is a time cost or a fuel cost.

38. The system of claim 36, where the humanized navigation instruction includes a visual or audio confirmation that an alternative route is being calculated.

39. The system of claim 38, where if the calculated cost exceeds a threshold value, an action is initiated.

40. The system of claim 39, where the action is one or more of sending a text message, e-mail, telephone call and tweet to another device.
